(19) United States
(12) Patent Application Publication
(10) Pub. No.: US 2009/0068479 A1
(43) Pub. Date: Mar. 12, 2009

(54) Moisture-reactive adhesive compositions with very low temperature dependency of the shear modulus

(75) Inventors: Martin Konstanzer, Zurich (CH); Urs Burckhardt, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/222,507

(22) Filed: Aug. 11, 2008

(30) Foreign Application Priority Data
Sep. 11, 2007 (EP) 07116117.8
Oct. 4, 2007 (CH) 01545/2007

(51) Int. Cl. B32B 15/095; B32B 37/12; C08G 18/00

(52) U.S. Cl. 428/457; 156/331.7; 528/44; 528/68; 428/474.4

(57) ABSTRACT

The present invention relates to moisture-reactive adhesive compositions which comprise a specific dialdimine of the formula (I) and also a polyurethane polymer P1 which is liquid at room temperature and contains isocyanate groups. These compositions are notable for a very low temperature dependency of the shear modulus, i.e. after 7 days' storage at room temperature and 50% relative humidity they feature a ratio of the shear modulus measured at −20° C. to the shear modulus measured at 23° C. of less than 1.7.

These adhesive compositions are suitable more particularly as glazing adhesives for means of transport.

### FILED OF THE INVENTION

The invention pertains to the field of moisture-reactive adhesives, more particularly that of moisture-reactive, one-component, polyurethane glazing adhesives.

### BACKGROUND ART

Moisture-reactive adhesives have been used for some time. Moisture-reactive one-component polyurethane adhesives more particularly are in widespread use in industrial operations, such as in vehicle construction. One conventional application thereof is as glazing adhesives in the installation of windows in vehicles, i.e. in the adhesively bonded installation of glazing sheets into the vehicle body.

These known one-component polyurethane adhesives exhibit a very marked temperature dependency of the shear modulus. Particularly marked is the drop in shear modulus between −20° C. and 23° C. The primary restriction on the adhesives formulator in terms of his or her freedom to formulate is imposed at the top end by the value of the low-temperature modulus (−20° C.) of the adhesive, in order to prevent substrate fracture at cold temperatures. In the case of glazing, the critical substrate is glass. For a glazing adhesive, accordingly, the critical value of the shear modulus at −20° C. is approximately 6 MPa. As a result of the strong temperature dependency, however, adhesives of this kind are nevertheless of very low modulus at high temperatures (at 23° C., more particularly at 80° C.), but this is disadvantageous for mechanical exposure of the bonded assembly at relatively high temperatures. The known polyurethane adhesives exhibit a strong temperature dependency of the shear modulus. In particular there is a marked drop in the shear modulus between −20° C. and 23° C. As a result, polyurethane adhesives of this kind used as glazing adhesives have shear moduli in the range from 230C to 80° C. that are well below 6 MPa, typically 3 MPa or less.

### BRIEF DESCRIPTION OF THE INVENTION

It is an object of the present invention, therefore, to provide adhesives for which the temperature dependency of the shear modulus is minimized.

Surprisingly it has emerged that a moisture-reactive adhesive composition according to Claim 1 has a very low temperature dependency of the shear modulus. Hence adhesive bonds are made possible that exhibit very similar shear moduli over a broad temperature range and are therefore easier to calculate. It is now possible, moreover, to formulate adhesives which exhibit very high shear moduli at room temperature and/or at 80° C. and nevertheless at −20° C. exhibit only a shear modulus which does not harbour any risk of substrate fracture. Adhesives of this kind may now have shear modulus values, even at these temperatures, which lie close to the substrate fracture value. This possibility now makes it possible to take entirely new pathways in the design of adhesive bonds, said pathways being previously closed off.

More particularly it is now possible to obtain the maximum torsional stiffness of the body via the installed glazing sheet, with the consequence that the shear modulus of the glazing adhesive over the entire temperature range from −20° C. to 80° C. is extremely close to 6 MPa and the shear modulus exhibits an extremely low temperature dependency.

Further aspects of the invention are formed by the uses of the moisture-reactive adhesive composition according to Claim 15 and 16 and also by a bonded article according to Claim 18.

Further aspects of the invention are subject matter of further independent claims. Particularly preferred embodiments of the invention are subject matter of the dependent claims.

### Ways of Implementing the Invention

The present invention in a first aspect provides moisture-reactive adhesive compositions which comprise
a) at least one dialdimine of formula (I),

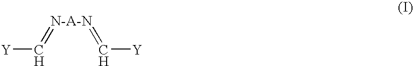

and also
b) at least one polyurethane polymer P1 which is liquid at room temperature and contains isocyanate groups,

where A stands for a divalent aliphatic, cycloaliphatic or arylaliphatic hydrocarbon radical having 2 to 15 C atoms, and Y stands for the radical of an aldehyde following removal of an O═CH group.

Moreover, after 7 days' storage at room temperature and 50% relative humidity, the adhesive compositions have a ratio of the shear modulus measured at −20° C. to the shear modulus measured at 23° C. of less than 1.7, more particularly less than 1.5, preferably less than 1.4, the shear moduli having been measured at the stated temperatures according to DIN 54 451.

The term “polymer” embraces in the present document on the one hand a collective of chemically uniform macromolecules which nevertheless differ in respect of degree of polymerization, molar mass and chain length and have been prepared by a polymerization reaction (addition polymerization, polyaddition, polycondensation). On the other hand the term also embraces derivatives of such a collective of macromolecules from polymerization reactions, in other words compounds which have been obtained by reactions, such as addition reactions or substitution reactions, of functional groups on existing macromolecules and which may be chemically uniform or chemically non-uniform. The term, furthermore, also embraces what are called prepolymers, in other words reactive oligomeric preadducts whose functional groups have participated in the synthesis of macromolecules.

The term “polyurethane polymer” embraces all polymers which are prepared by the diisocyanate polyaddition process. This also includes those polymers which are virtually or entirely free from urethane groups. Examples of polyurethane polymers are polyether-polyurethanes, polyester-polyurethanes, polyether-polyureas, polyureas, polyester-polyureas, polyisocyanurates and polycarbodiimides.

Substance names beginning with “poly”, such as polyol or polyisocyanate, in the present document identify substances which formally contain per molecule two or more of the functional groups that occur in their name.

The term “cycloaliphatic primary diamine”, here and below, identifies an amine which contains two primary amino groups which are attached to a hydrocarbon radical which is cycloaliphatic or has cycloaliphatic components.

The term “primary amino group” in the present document identifies an NH₂ group which is attached to an organic radical, whereas the term “secondary amino group” identifies an NH group which is attached to two organic radicals, which may also together be part of a ring. Accordingly an amine which contains a primary amino group is referred to as a “primary amine”, while one with a secondary amino group is referred to, correspondingly, as a “secondary amine” and one with a tertiary amino group as a “tertiary amine”.

An “aliphatic amino group” is an amino group which is attached to an aliphatic, cycloaliphatic or arylaliphatic radical. It therefore differs from an “aromatic amino group”, which is attached directly to an aromatic or heteroaromatic radical, such as in aniline or 2-aminopyridine, for example. “Room temperature” refers to 23° C.

The “open time” in this document identifies the time during which the composition can be processed after the isocyanate groups of the polyisocyanate have come into contact with water.

The epithet “one-component” refers in the present document to a curable composition in which all of the constituents of the composition are stored as a mixture in the same container, and which is stable on storage at room temperature over a prolonged period, in other words undergoes no change, or no substantial change, in its application properties or service properties as a result of the storage, and which, after application, cures through exposure to moisture and/or heat.

An “adhesive”, or an “adhesive composition”, has in this document, after 7 days storage at room temperature and 50% relative humidity, a shear modulus at 23° C., measured according to DIN 54 451, of more than 1 MPa, and is therefore distinct from a “sealant” or a “sealant composition”, which has a shear modulus at 23° C., measured according to DIN 54 451, of not more than 1 MPa.

Dashed lines in formulae in this document represent in each case the bond between a substituent and the associated molecular radical.

The adhesive composition comprises at least one dialdimine of the formula (I). Particularly preferred dialdimines of the formula (I) are those whose α carbon with respect to the imino group has no hydrogen atoms, i.e., more particularly, dialdimines in which the radical Y has the formula (II a) or (II b)

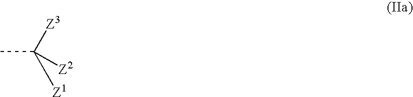

where

Z¹ and Z² either
independently of one another each stand for a monovalent hydrocarbon radical having 1 to 12 C atoms, or
together stand for a divalent hydrocarbon radical having 4 to 20 C atoms which is part of an unsubstituted or substituted carbocyclic ring having 5 to 8, preferably 6, C atoms; and

Z³ either
stands for a branched or unbranched alkyl, cycloalkyl, alkylene or cycloalkylene group,
or stands for a substituted or unsubstituted aryl or arylalkyl group, or stands for a radical of the formula O—R² or

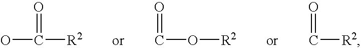

where R²
stands for an aryl, arylalkyl, cycloalkyl or alkyl group and is in each case substituted or unsubstituted, more particularly stands for an aryl, arylalkyl, cycloalkyl or alkyl group having 1 to 32 C atoms, which, if desired, contains ether oxygen atoms,
or stands for a radical of the formula (VI)

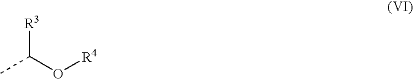

where
R³ stands for a hydrogen atom or for an alkyl, cycloalkyl or arylalkyl group, more particularly having 1 to 12 C atoms, preferably for a hydrogen atom, and
R⁴ either
   stands for a hydrocarbon radical having 1 to 30 C atoms, which, where appropriate, contains ether oxygen atoms, or stands for a radical

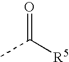

where R⁵ stands for a hydrogen atom or for a hydrocarbon radical having 1 to 30, more particularly 11 to 30, C atoms;

and where

Z⁴ either
stands for a substituted or unsubstituted aryl or heteroaryl group which has a ring size of 5 to 8, preferably 6, atoms,
or stands for

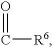

where R⁶
stands for a hydrogen atom or for an alkoxy group,
or stands for a substituted or unsubstituted alkenyl or arylalkenyl group having at least 6 C atoms.

A dialdimine (I) can be prepared from at least one diamine of the formula (III) and at least one aldehyde of the formula (IV), more particularly at least one aldehyde of the formula (IV a) or (IV b).

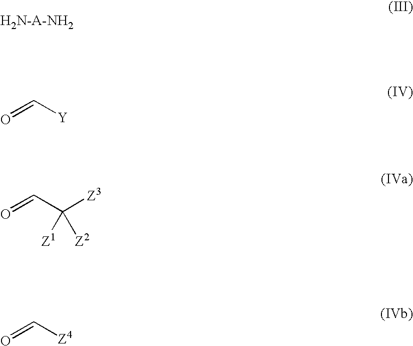

The reaction between at least one diamine of the formula (III) and at least one aldehyde of the formula (IV) or (IV a) or (IV b) takes place in a condensation reaction with elimination of water. Such condensation reactions are very well known and have been described, as for example in Houben-Weyl, “Methoden der organischen Chemie”, Vol. XI/2, page 73ff. The aldehyde here is used stoichiometrically or in a stoichiometric excess in relation to the primary amino groups of the amine. Such condensation reactions are carried out typically in the presence of a solvent, by means of which the water formed during the reaction is removed azeotropically. For the preparation of the dialdimines of the formula (I), however, a preparation process without using solvents is preferred, with the water formed during the condensation reaction being removed from the reaction mixture directly by the application of a vacuum.

Suitable aldehydes are, firstly, aldehydes of the formula (IV) such as, for example, propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxaldehyde and diphenylacetaldehyde.

Suitable aldehydes are, secondly, aldehydes of the formula (IV b), such as, for example, aromatic aldehydes, such as benzaldehyde, 2- and 3- and 4-tolualdehyde, 4-ethyl- and 4-propyl- and 4-isopropyl- and 4-butyl-benzaldehyde 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3- and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7- and 8-position isomers, and also anthracene-9-carbaldehyde; and also, furthermore, glyoxal, glyoxalic esters such as methyl glyoxalate, for example, cinnamaldehyde and substituted cinnamaldehydes.

Aldehydes suitable more particularly are those known as tertiary aldehydes, in other words aldehydes of the formula (IV a) which have no hydrogen atom in the position a to the carbonyl group.

Examples of suitable aldehydes of the formula (IV a) are pivalaldehyde (2,2-dimethylpropanal), 2,2-dimethylbutanal, 2,2-diethylbutanal, 1-methylcyclopentanecarboxaldehyde, 1-methylcyclohexanecarboxaldehyde; ethers formed from 2-hydroxy-2-methylpropanal and alcohols such as propanol, isopropanol, butanol and 2-ethylhexanol; esters formed from 2-formyl-2-methylpropionic acid or 3-formyl-3-methylbutyric acid and alcohols such as propanol, isopropanol, butanol and 2-ethylhexanol; esters formed from 2-hydroxy-2-methylpropanal and carboxylic acids such as butyric acid, isobutyric acid and 2-ethylhexanoic acid; and also the ethers and esters, described below as being particularly suitable, of 2,2-disubstituted 3-hydroxypropanals, -butanals or analogous higher aldehydes, more particularly of 2,2-dimethyl-3-hydroxypropanal.

Additionally suitable aldehydes of the formula (IV a) are aldehydes of the formula (V).

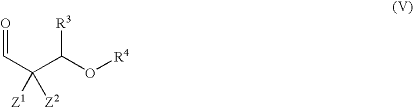

In formula (V) Z¹, Z², R³ and R⁴ have the definitions already stated.

Preferably in formula (V) Z¹ and Z² each stand for a methyl group and R³ stands for a hydrogen atom.

A particularly suitable aldehyde of the formula (V) is in one embodiment an aldehyde ALD1 of the formula (V a),

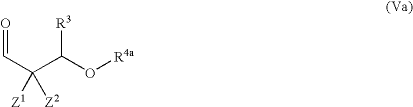

where R^{4a} stands for a hydrocarbon radical having 1 to 30 C atoms, more particularly 11 to 30 C atoms, which, where appropriate, contains ether oxygen atoms. In formula (V a) Z¹, Z² and R³ have the definitions already stated.

The aldehydes ALD1 of the formula (V a) represent ethers of aliphatic, cycloaliphatic or arylaliphatic 2,2-disubstituted 3-hydroxyaldehydes with alcohols or phenols of the formula R^{4a}—OH, examples being fatty alcohols or else phenols. Suitable 2,2-disubstituted 3-hydroxyaldehydes are in turn obtainable from aldol reactions, more particularly crossed aldol reactions, between primary or secondary aliphatic aldehydes, more particularly formaldehyde, and secondary aliphatic, secondary cycloaliphatic or secondary arylaliphatic aldehydes, such as, for example, isobutyraldehyde, 2-methylbutyraldehyde, 2-ethylbutyraldehyde, 2-methylvaleraldehyde, 2-ethylcaproaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde(hydratropaldehyde) or diphenylacetaldehyde. Examples of suitable 2,2-disubstituted 3-hydroxyaldehydes are 2,2-dimethyl-3-hydroxypropanal, 2-hydroxymethyl-2-methylbutanal, 2-hydroxymethyl-2-ethylbutanal, 2-hydroxymethyl-2-methyl pentanal, 2-hydroxymethyl-2-ethylhexanal, 1 -hydroxymethylcyclopentanecarboxaldehyde, 1 -hydroxymethylcyclohexanecarboxaldehyde 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal.

Examples of such aldehydes ALD1 of the formula (V a) are 2,2-dimethyl-3-phenoxypropanal, 3-cyclohexyloxy-2,2-dimethylpropanal, 2,2-dimethyl-3-(2-ethylhexyloxy)propanal, 2,2-dimethyl-3-lauroxypropanal and 2,2-dimethyl-3-stearoxypropanal.

A particularly suitable aldehyde of the formula (V) is in a further embodiment an aldehyde ALD2 of the formula (V b),

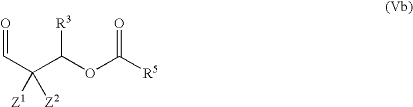

In formula (V b) Z¹, Z², R³ and R⁵ have the definitions already stated.

R⁵ stands for a hydrogen atom or for a hydrocarbon radical having 1 to 30, more particularly 11 to 30, C atoms.

The aldehydes ALD2 of the formula (V b) represent esters of the 2,2-disubstituted 3-hydroxyaldehydes already described, such as, for example, 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal, with carboxylic acids such as formic acid, acetic acid, propionic acid, butyric acid, isobutyric acid, valeric acid and caproic acid.

Examples of such aldehydes ALD2 of the formula (V b) are 2,2-dimethyl-3-formyloxypropanal, 3-acetoxy-2,2-dimethylpropanal, 2,2-dimethyl-3-propionoxypropanal, 3-butyroxy-2,2-dimethylpropanal, 2,2-dimethyl-3-isobutyroxypropanal, 2,2-dimethyl-3-pentoyloxypropanal, 2,2-dimethyl-3-hexoyloxypropanal, 3-benzoyloxy-2,2-dimethylpropanal, 3-cyclohexanoyloxy-2,2-dimethylpropanal, 2,2-dimethyl-3-(2-ethylhexyloxy)-propanal, 2,2-dimethyl-3-lauroyloxypropanal, 2,2-dimethyl-3-myristoyloxypropanal, 2,2-dimethyl-3-palmitoyloxypropanal, 2,2-dimethyl-3-stearoyloxypropanal, and also analogous esters of other 2,2-disubstituted 3-hydroxyaldehydes.

Preferred aldehydes are the aldehydes of the formula (IV a) and of the formula (IV b).

More particular preference is given to the aldehydes of the formula (V).

The most preferred are the aldehydes ALD2 of the formula (V b), more particularly 2,2-dimethyl-3-lauroyloxypropanal.

Examples of suitable primary diamines of the formula (III) are primary aliphatic, cycloaliphatic or arylaliphatic diamines, examples being ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamine (DAMP), 1,5-pentanediamine, 1,5-diamino-2-methylpentane (MPMD), 1,6-hexanediamine, 2,5-dimethyl-1,6-hexanediamine, 2,2,4- and 2,4,4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- and 1,4-diaminocyclohexane, bis(4-aminocyclohexyl)methane, bis(4-amino-3-methylcyclohexyl)methane, 1-amino-3-aminomethyl-3,5,5-trimethylcyclohexane (isophoronediamine or IPDA), 2- and 4-methyl-1,3-diaminocyclohexane and mixtures thereof, 1,3- and 1,4-bis(aminomethyl)cyclohexane, 2,5(2,6)-bis(aminomethyl)bicyclo[2.2.1]heptane (NBDA), 3(4),8(9)-bis(aminomethyl)-tricyclo[5.2.1.0^{2,6}]decane, 1,4-diamino-2,2,6-trimethylcyclohexane (TMCDA) and also 1,3- and 1,4-xylylenediamine.

Preferred diamines of the formula (III) are symmetrical diamines. “Symmetrical diamines” for the purposes of the present document are diamines of the formula (III) in which the two primary amino groups are symmetry-equivalent, i.e. can be converted into one another by means of an operation of symmetry, such as a rotation or a mirror-imaging, for example.

Preferred symmetrical diamines of the formula (III) are selected from the group consisting of ethylenediamine, 1,3-propanediamine, 1,4-butanediamine, 1,5-pentanediamine, 1,6-hexanediamine, 1,8-octanediamine, 1,10-decanediamine, 1,12-dodecanediamine, 1,3- and 1,4-diaminocyclohexane, bis(4-aminocyclohexyl)methane, 1,3- and 1,4-bis(aminomethyl)-cyclohexane and also 1,3- and 1,4-xylylenediamine.

Particularly preferred symmetrical diamines of the formula (III) are selected from the group consisting of ethylene diamine, 1,6-hexanediamine, 1,12-dodecanediamine, 1,4-diaminocyclohexane, bis(4-aminocyclohexyl)-methane, 1,3-bis(aminomethyl)cyclohexane and also 1,3-xylylenediamine.

The most preferred symmetrical diamine of the formula (III) is 1,6-hexanediamine.

The radical A in the dialdimine of the formula (I) corresponds to the diamine of the formula (III) following removal of the two amino groups.

The adhesive composition further comprises at least one polyurethane polymer P1 which is liquid at room temperature and contains isocyanate groups.

A suitable polyurethane polymer P1 containing isocyanate groups is obtainable through the reaction of at least one polyol with at least one polyisocyanate.

Polyols which can be used for preparing a polyurethane polymer P1 include, for example, the following polyols or mixtures thereof:
Polyetherpolyols, also called polyoxyalkylenepolyols or oligoetherols, which are polymerization products of ethylene oxide, 1,2-propylene oxide, 1,2- or 2,3-butylene oxide, oxetane, tetrahydrofuran or mixtures thereof, optionally polymerized with the aid of a starter molecule such as, for example, water, ammonia, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediolsi octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the aforementioned compounds. Use may be made not only of polyoxyalkylenepolyols which have a low degree of unsaturation (measured according to ASTM D-2849-69 and reported in milliequivalents of unsaturation per gram of polyol (meq/g)), prepared for example with the aid of what are known as double metal cyanide complex catalysts (DMC catalysts), but also of polyoxyalkylenepolyols having a higher degree of unsaturation, prepared for example with the aid of anionic catalysts such as NaOH, KOH, CsOH or alkali metal alkoxides.

Particularly suitable polyether polyols are polyoxyalkylenediols and -triols, more particularly polyoxyalkylenediols. Particularly suitable polyoxyalkylenediols and triols are polyoxyethylenediols and -triols and also polyoxypropylened iols and -triols.

Particularly suitable are polyoxypropylenediols and -triols having a degree of unsaturation lower than 0.02 meq/g and a molecular weight in the range from 1000 to 30 000 g/mol, and also polyoxypropylenediols and -triols having a molecular weight of 400 to 8000 g/mol. By “molecular weight” or “molar weight” is meant, in the present document, always the molecular weight average Mₙ. Of more particular suitability are polyoxypropylene diols having a degree of unsaturation lower than 0.02 meq/g and a molecular weight in the range from 1000 to 12 000, more particularly between 1000 and 8000 g/mol. Such polyetherpolyols are sold, for example, under the trade name Acclaim® by Bayer.

Likewise particularly suitable are what are known as “EO-endcapped” (ethylene oxide-endcapped) polyoxypropylenediols and -triols. The latter are special polyoxypropylene-polyoxyethylenepolyols which are obtained, for example, by alkoxylating pure polyoxypropylenepolyols, after the end of the polypropoxylation, with ethylene oxide and which as a result contain primary hydroxyl groups.
Styrene-acrylonitrile- or acrylonitrile-methyl methacrylate-grafted polyetherpolyols.
Polyesterpolyols, also called oligoesterols, prepared by known methods, more particularly by the polycondensation of hydroxycarboxylic acids or the polycondensation of aliphatic and/or aromatic polycarboxylic acids with dihydric or polyhydric alcohols.

Of more particular suitability are polyesterpolyols prepared from dihydric to trihydric, more particularly dihydric, alcohols, such as, for example, ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic dicarboxylic or tricarboxylic acids, more particularly dicarboxylic acids, or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyesterpolyols from lactones such as, for example, from ε-caprolactone and starters such as the aforementioned dihydric or trihydric alcohols.

Particularly suitable polyesterpolyols are polyesterdiols.
Polycarbonatepolyols, of the kind obtainable through reaction, for example, of the abovementioned alcohols—those used for the synthesis of the polyesterpolyols—with dialkyl carbonates, such as dimethyl carbonate, diaryl carbonates, such as diphenyl carbonate, or phosgene.

Particularly suitable are polycarbonatediols.
Block copolymers which carry at least two hydroxyl groups and which contain at least two different blocks with polyether, polyester and/or polycarbonate structure of the type described above.
Polyacrylate- and polymethacrylatepolyols.
Polyhydroxy-functional fats and oils, examples being natural fats and oils, more particularly castor oil; or polyols obtained by chemical modification of natural fats and oils—and referred to as oleochemical polyols—such as, for example, the epoxy polyesters and epoxy polyethers obtained by epoxidation of unsaturated oils and subsequent ring opening with carboxylic acids or alcohols, respectively, or polyols obtained by hydroformylation and hydrogenation of unsaturated oils; or polyols obtained from natural fats and oils by degradation processes such as alcoholysis or ozonolysis and subsequent chemical linkage, as for example by transesterification or dimerization, of the degradation products thus obtained or derivatives thereof. Suitable degradation products of natural fats and oils are, more particularly, fatty acids and fatty alcohols and also fatty acid esters, more particularly the methyl esters (FAME), which can be derivatized, for example, by hydroformylation and hydrogenation to form hydroxy-fatty acid esters.
Polyhydrocarbon-polyols, also called oligohydrocarbonols, such as, for example, polyhydroxy-functional polyolefins, polyisobutylenes, polyisoprenes; polyhydroxy-functional ethylene-propylene, ethylene-butylene or ethylene-propylene-diene copolymers, of the kind produced by the company Kraton Polymers, for example; polyhydroxy-functional polymers of dienes, more particularly of 1,3-butadiene, which may be prepared more particularly from anionic polymerization as well; polyhydroxy-functional copolymers from dienes such as 1,3-butadiene or diene mixtures and vinylmonomers such as styrene, acrylonitrile, vinyl chloride, vinyl acetate, vinyl alcohol, isobutylene and isoprene, examples being polyhydroxy-functional acrylonitrile/butadiene copolymers, which are preparable, for example, from carboxyl-terminated acrylonitrile/butadiene copolymers (available commercially under the name Hycar® CTBN from Noveon) and epoxides or amino alcohols; and also hydrogenated, polyhydroxy-functional polymers or copolymers of dienes.

These stated polyols preferably have an average molecular weight of 250-30 000 g/mol, more particularly of 400-20 000 g/mol, and preferably have an average OH functionality in the range from 1.6 to 3.

In addition to these stated polyols it is possible to use small amounts of low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butane diols, pentanediols, hexanediols, heptanediols, octanediols, nonanediols, decanediols, undecanediols, 1,3- and 1,4-cyclohexanedimethanol, hydrogenated bisphenol A, dimeric fatty alcohols such as dimer fatty acid diols, for example, 1,1,1-trimethylolethane, 1,1,1-trimethylolpropane, glycerol, pentaerythritol, low molecular weight alkoxylation products of the aforementioned dihydric and polyhydric alcohols, and also mixtures of the aforementioned alcohols, when preparing a polyurethane polymer P1.

Polyisocyanates which can be used for the preparation of a polyurethane polymer P1 are aliphatic, cycloaliphatic or aromatic polyisocyanates, more particularly diisocyanates.

Suitability is possessed more particularly by the following:
1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine diisocyanate and lysine ester diisocyanate, cyclohexane 1,3- and -1,4-diisocyanate and any desired mixtures of these isomers, 1-methyl-2,4- and -2,6-diisocyanatocyclohexane and any desired mixtures of these isomers (HTDI or H₆TDI), 1-isocyanato-3,3,5-trimethyl-5-isocyanatomethylcyclohexane (isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene.
2,4- and 2,6-toluylene diisocyanate and any desired mixtures of these isomers (TDI), 4,4′-, 2,4′- and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatobiphenyl (TODI), dianisidine diisocyanate (DADI).
Oligomers and polymers of the aforementioned monomeric diisocyanates.
Any desired mixtures of the aforementioned polyisocyanates.

Preference is given to monomeric diisocyanates, more particularly MDI, TDI, HDI, and IPDI.

A polyurethane polymer P1 is prepared in a known way directly from the polyisocyanates and the polyols, or by stepwise adduction methods, of the kind also known as chain extension reactions.

In one preferred embodiment the polyurethane polymer P1 is prepared by a reaction of at least one polyisocyanate and at least one polyol, the isocyanate groups being present in a stoichiometric excess over the hydroxyl groups. Advantageously the ratio between isocyanate groups and hydroxyl groups is 1.3 to 10, more particularly 1.5 to 5.

The polyurethane polymer P1 has a molecular weight of preferably above 500 g/mol, more particularly one of between 1000 and 30 000 g/mol.

Additionally the polyurethane polymer P1 preferably has an average NCO functionality in the range from 1.8 to 3.

It has emerged as being particularly suitable if the moisture-reactive adhesive composition comprises two or more polyurethane polymers P1, preferably one being based on a polyol having a molecular weight below 2000 g/mol. The combination of a polyetherpolyol-based polyurethane polymer P1 and of a polycarbonatepolyol-based polyurethane polymer P1 has proved to be particularly advantageous.

On the other hand it has emerged that it is particularly advantageous to combine at least one polyurethane polymer P1 which is liquid at room temperature and contains isocyanate groups with at least one polyurethane polymer P2 which is solid at room temperature and contains isocyanate groups. Polyurethane polymers P2 which are solid at room temperature and contain isocyanate groups can be prepared from the polyols and polyisocyanates that have already been described in connection with the preparation of the polyurethane polymers P1. Particularly preferred as polyurethane polymer P2 are polyurethane polymers which are solid at room temperature, which contain isocyanate groups and which are prepared from polyesterpolyols and/or polycarbonatepolyols.

It has emerged that it is particularly advantageous if the moisture-reactive adhesive composition comprises organic and inorganic fillers. Examples of fillers of this kind are ground or precipitated calcium carbonates, coated where appropriate with fatty acids, more particularly stearates, or else barytes (BaSO₄, also called heavy spar), finely ground quartzes, calcined kaolins, aluminium oxides, aluminium hydroxides, silicas, more particularly highly dispersed silicas from pyrolysis operations, carbon blacks, especially industrially manufactured carbon blacks (referred to below as “carbon black”), PVC powders or hollow beads.

Most-preferred fillers are carbon blacks, calcined kaolins and chalks and also mixtures thereof with one another.

The total amount of fillers is preferably between 25% and 55%, more particularly 30%-45%, by weight, based on the moisture-reactive adhesive composition. Most preferably the moisture-reactive adhesive composition contains 10%-35%, more particularly 10%-30%, by weight of carbon black.

Where appropriate the moisture-reactive adhesive composition comprises further constituents, more particularly auxiliaries and additives that are typically used in polyurethane compositions, examples of such auxiliaries and additives being as follows:
plasticizers, examples being carboxylic esters such as phthalates, for example dioctyl phthalate, diisononyl phthalate or diisodecyl phthalate, adipates, for example dioctyl adipate, azelates and sebacates, organic phosphoric and sulphonic esters or polybutenes;
non-reactive thermoplastic polymers, such as, for example, homopolymers or copolymers of unsaturated monomers, more particularly those from the group encompassing ethylene, propylene, butylene, isobutylene, isoprene, vinyl acetate and alkyl(meth)acrylates, more particularly polyethylenes (PE), polypropylenes (PP), polyisobutylenes, ethylene-vinyl acetate copolymers (EVA) and atactic poly-α-olefins (APAO);
solvents;
fibres, of polyethylene for example;
pigments, examples being titanium dioxide or iron oxides;
catalysts which accelerate the hydrolysis of the aldimino groups, more particularly acids, examples being organic carboxylic acids such as benzoic acid, salicylic acid, or 2-nitrobenzoic acid, organic carboxylic anhydrides such as phthalic anhydride, hexahydrophthalic anhydride and hexahydromethylphthalic anhydride, silyl esters of organic carboxylic acids, organic sulphonic acids such as methanesulphonic acid, p-toluenesulphonic acid or 4-dodecylbenzenesulphonic acid, sulphonic esters, other organic or inorganic acids, or mixtures of the aforementioned acids and acid esters;
catalysts which accelerate the reaction of the isocyanate groups, examples being organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris(neodecanoate), and compounds containing tertiary amino groups, such as 2,2′-dimorpholinodiethyl ether and 1,4-diazabicyclo[2.2.2]octane;
rheology modifiers such as, for example, thickeners or thixotropic agents, for example urea compounds, polyamide waxes, bentonites or fumed silicas;
reactive diluents and crosslinkers, examples being monomeric diisocyanates such as MDI, PMDI, TDI, HDI, 1,12-dodecamethylene diisocyanate, cyclohexane 1,3- or 1,4-diisocyanate, IPDI, perhydro-2,4′- and -4,4′-diphenylmethane diisocyanate, 1,3- and 1,4-tetramethylxylylene diisocyanate, and also oligomers and derivatives of these polyisocyanates, in the form more particularly of isocyanurates, carbodiimides, uretonimines, biurets, allophanates or iminooxadiazinediones, adducts of monomeric polyisocyanates with short-chain polyols, and also adipic dihydrazide and other dihydrazides, and also polyisocyanates with blocked aromatic isocyanate groups, such as, for example, the Desmocap® products 11, 12 and XP 2540 (all from Bayer) and the Trixene® products BI 7641, BI 7642, BI 7770, BI 7771, BI 7772, BI 7774 and BI 7779 (all from Baxenden);
blocked amines, in the form for example of ketimines, oxazolidines, enamines or other aldimines;
dryers, such as, for example, molecular sieves, calcium oxide, high-reactivity isocyanates such as p-tosyl isocyanate, orthoformic esters, alkoxysilanes such as tetraethoxysilane, organoalkoxysilanes such as vinyltrimethoxysilane, and organoalkoxysilanes which have a functional group in the position α to the silane group;
adhesion promoters, more particularly organoalkoxysilanes (“silanes”) such as, for example, epoxysilanes, vinylsilanes, (meth)acrylosilanes, isocyanatosilanes, carbamatosilanes, alkylsilanes, S-(alkylcarbonyl)-mercaptosilanes and aldiminosilanes, and also oligomeric forms of these silanes;
stabilizers against heat, light and UV radiation;
flame retardants;
surface-active substances such as, for example, wetting agents, flow control agents, deaerating agents or defoamers;
biocides such as, for example algicides, fungicides or fungal growth inhibitors.

If using such further constituents it is advantageous to ensure that they do not greatly affect the storage stability of the composition. This means that these constituents must not to any significant extent trigger the reactions that lead to crosslinking, such as hydrolysis of the aldimino groups or crosslinking of the isocyanate groups, during storage. More particularly this means that all of these constituents ought to contain no water, or traces of water at most. It may be sensible to carry out chemical or physical drying of certain constituents before mixing them into the composition.

The moisture-reactive adhesive composition preferably comprises at least one catalyst. The catalyst is more particularly one of the stated acids, such as benzoic acid or salicylic acid, or one of the stated metal compounds, or one of the stated tertiary amines. It may well be advantageous to use different catalysts, and/or different types of catalyst.

The moisture-reactive adhesive composition described is produced and stored in the absence of moisture. It is storage-stable—that is, it can be stored in the absence of moisture in a suitable pack or arrangement, such as a drum, bucket, pouch, cartridge or bottle, for example, over a time of several months, for example, without undergoing alteration in its application properties or in its properties after curing to an extent that is relevant for its service. Depending on the consistency of the composition it is customary to determine the storage stability via the measurement of the viscosity.

A property of the aldimino groups of the aldimine of the formula (I) is to undergo hydrolysis on contact with moisture. The primary amino groups that are formally liberated in this procedure react with the isocyanate groups that are present in the moisture-curing adhesive composition described to form urea groups, and the corresponding aldehyde of the formula Y—CHO is liberated. Isocyanate groups which are in excess in relation to the aldimino groups react directly with moisture and likewise form urea groups. Any blocked isocyanate groups present generally react, with release of the blocking agent, likewise to form urea groups, this reaction possibly taking place only on exposure to heat. As the result of these reactions, the composition cures to a solid material; this process is also referred to as crosslinking. The reaction of the isocyanate groups with the hydrolyzing aldimine need not necessarily take place via free amino groups. It will be appreciated that reactions with intermediates of the hydrolysis reaction are possible as well. It is conceivable, for example, for a hydrolyzing aldimino group in the form of a hemiaminal to react directly with an isocyanate group.

Either the water needed for the curing reaction may come from the air (atmospheric humidity), or else the composition may be brought into contact with a water-containing component, by being sprayed, for example, or a water-containing component may be added to the composition at the time of application.

On contact with moisture, the moisture-reactive adhesive composition described cures generally without the formation of bubbles. The cure rate can be influenced via the nature and amount of one or more of any catalysts present, via the temperature prevailing during the curing procedure, and also via the atmospheric humidity and/or the amount of water added.

As the result of these reactions with water, more particularly in the form of atmospheric humidity, the moisture-reactive adhesive composition described undergoes crosslinking and, finally, cures to a solid material.

The fraction of the dialdimine of the formula (I) in the moisture-reactive composition is more particularly calculated such that the ratio of the number of aldimino groups to the number of NCO groups in the composition is 0.5-<1, preferably at least 0.6-0.8, most preferably 0.65-0.75.

It has emerged that the presence of the dialdimine of the formula (I) is substantially responsible for the temperature independence, or reduction in the temperature dependency, of the shear modulus. Hence it is a further aspect of the invention that the dialdimine of the formula (I), as described above, can be used for reducing the temperature dependency of the shear modulus in accordance with DIN 54 451 of moisture-reactive polyurethane adhesives.

By virtue of the present invention, the shear modulus of the adhesive at elevated temperatures (e.g. at room temperature or at 80° C.) can be significantly increased. The maximum increase, however, is guided in practice by the consideration that the modulus of the adhesive in the anticipated temperature use range should approximate, but not exceed, those of the materials to be bonded.

In principle it is possible for a wide variety of different substrates S1 and S2 to be bonded by means of the moisture-reactive adhesive composition described, it being possible for the substrates S1 and S2 to be alike or different from one another. Suitable substrates S1 and/or S2 are, for example, inorganic substrates such as glass, glass ceramic, concrete, mortar, brick, tile, gypsum and natural stones such as granite or marble; metals or alloys such as aluminium, steel, non-ferrous metals, galvanized metals; organic substrates such as leather, fabrics, paper, wood, resin-bound wood-based materials, resin-textile composite materials, plastics such as polyvinyl chloride (unplasticized and plasticized PVC), acrylonitrile-butadiene-styrene copolymers (ABS), SMC (sheet moulding composites), polycarbonate (PC) polyamide (PA), polyesters, polymethylmethacrylate (PMMA), epoxy resins, polyurethanes (PUR), polyoxymethylene (POM), polyolefins (PO), more particularly polyethylene (PE) or polypropylene (PP) surface-treated by means of plasma, corona or flaming, or ethylene/propylene copolymers (EPM) and ethylene/propylene-diene terpolymers (EPDM); coated substrates such as powder-coated metals or alloys; and also paints and finishes, more particularly automotive finishes.

The moisture-reactive adhesive composition described can be used as an elastic adhesive for all kinds of adhesive bonds. More particularly it is suitable as an adhesive for industrial applications. The low temperature dependency of the moisture-reactive adhesive composition described allows adhesive bonds implemented therewith to be more readily calculable. Thus it is possible to implement bonds with adhesives which have a shear modulus at room temperature that is close to the substrate fracture value, without any need to be concerned about substrate fracture occurring at −20° C. This possibility makes it possible then to follow completely new pathways in the design of adhesive bonds.

The moisture-reactive adhesive composition described can be used to more particular effect, however, in the context of the adhesive bonding of glazing sheets in the construction of means of transport (i.e. as a glazing adhesive), more particularly in automotive engineering. As a result of the combination of materials to be bonded, i.e. glass sheet and metal, or painted metal, it is of great advantage that the shear modulus of the adhesive approximates to 6 MPa (measured according to DIN 54 451), but does not exceed this value, across the entire temperature range, i.e. from −20° C. to 80° C.

The advantage presents itself that the shear modulus of the moisture-reactive adhesive composition exhibits a low temperature dependency across the entire temperature range relevant for the service of a vehicle in practice, more particularly between −20° C. and 80° C. With this it is possible to formulate glazing adhesives which exhibit very high shear moduli, above 3 or even above 4 MPa (measured according to DIN 54 451), at room temperature and/or at 80° C., while at −20° C. have only a shear modulus which is still below 6 MPa (measured according to DIN 54 451) and hence does not harbour any risk of substrate fracture. This allows maximum torsional stiffness of the body to be achieved via the glazing sheet installed by bonding, something which is of great importance in vehicle construction, more particularly in automotive engineering.

The installation of glazing sheets in means of transport takes place in a manner which is known per se. In one typical version the adhesive is applied to the glazing sheet, typically to the glass ceramic present in the marginal region of the sheet, and then joined, within the open time of the adhesive, to the bodywork of the means of transport, more particularly a metal flange, which typically is painted. In another version the adhesive is applied to the bodywork of the means of transport, more particularly to a metal flange, which typically is painted, and then is joined, within the open time of the adhesive, to the glazing sheet, typically to the glass ceramic present in the marginal region of the sheet.

The moisture-reactive adhesive composition described has after 7 days' storage at room temperature and 50% relative humidity a shear modulus at 80° C., measured according to DIN 54 451, which is preferably more than 1 MPa, more particularly between 1 and 5 MPa.

The moisture-reactive adhesive composition described has after 7 days' storage at room temperature and 50% relative humidity a shear modulus at −20° C., measured according to DIN 54 451, which is preferably less than 6 MPa, preferably between 3 and 6 MPa, preferably between 4 and 6 MPa.

The moisture-reactive adhesive composition described has after 7 days' storage at room temperature and 50% relative humidity a shear modulus at 23° C., measured according to DIN 54 451, which is preferably more than 3 MPa, more particularly between 3 and 6 MPa, preferably between 4 and 6 MPa, more preferably between 3.5 and 5.5 MPa.

The moisture-reactive adhesive composition described has after 7 days' storage at room temperature and 50% relative humidity a shear modulus at 80° C., measured according to DIN 54 451, of preferably more than 2, more particularly of more than 3 MPa, preferably between 3 and 5 MPa.

The substrates may where necessary be pretreated prior to the application of the moisture-reactive adhesive composition described. Such pretreatments encompass, more particularly, physical and/or chemical cleaning methods, examples being abrading, sandblasting, brushing or the like, or treatment with cleaners or solvents, or the application of an adhesion promoter, an adhesion promoter solution or a primer.

Accordingly a further aspect of the invention is formed by a bonded article which is obtained by bonding of two substrates S1 and S2 by a moisture-reactive adhesive composition as described above and the curing of the adhesive composition by moisture.

More particularly the article is such that the substrate S1 is a sheet, more particularly a glass sheet, and the substrate S2 is a metal, more particularly a painted metal.

It is found that the moisture-reactive adhesive composition described cures without bubbles, attains good mechanical values and possesses rapid through-curing. Furthermore, effective adhesion can be achieved on a diversity of substrates, more particularly glass, ceramic, metal and paint.

### EXAMPLES

### Description of Measurement Methods

The amine content of the dialdimines prepared, in other words the amount of blocked amino groups in the form of aldimino groups, was determined by titrimetry (using 0.1N HClO₄ in glacial acetic acid, against crystal violet) and is always reported in mmol N/g.

### a) Preparation of Dialdimines

Dialdimine A-1

A round-bottomed flask was charged under nitrogen with 50.9 g (0.18 mol) of 2,2-dimethyl-3-lauroyloxypropanal. With vigorous stirring 10.0 g (0.17 mol N) of 1,6-hexanediamine (BASF; amine content 17.04 mmol N/g) were added slowly from a heated dropping funnel, the mixture warming and becoming increasingly cloudy. Thereafter the volatile constituents were removed under reduced pressure (10 mbar, 80° C.). Yield: 57.7 g of a clear, pale yellow oil having an amine content of 2.94 mmol N/g.

Dialdimine A-2

A round-bottomed flask was charged under nitrogen with 87.0 g (0.31 mol) of 2,2-dimethyl-3-lauroyloxypropanal. With vigorous stirring 20.0 g (0.29 mol N) of 1,3-xylylenediamine (Mitsubishi Gas Chemical; amine content 14.56 mmol N/g) were added slowly from a dropping funnel, the mixture warming and becoming increasingly cloudy. Thereafter the volatile constituents were removed under reduced pressure (10 mbar, 80° C.). Yield: 101.0 g of a clear, pale yellow oil having an amine content of 2.85 mmol N/g.

### b) Production of One-Component Elastic Glazing Adhesives

### Examples 1 and 2 and Comparative Example Ref.

For each example the respective constituents as per Table 1, in the parts by weight stated, were processed to a homogeneous paste in a vacuum mixer with exclusion of moisture, the paste was immediately dispensed into an internally coated aluminium cartridge, and the cartridge was given an airtight seal.

The polyurethane polymer PUP-1 was prepared as follows:

1300 g of polyoxypropylene-diol (Acclaim® 4200 N, Bayer; OH number 28.5 mg KOH/g), 2600 g of polyoxypropylene-polyoxyethylene-triol (Caradol® MD34-02, Shell; OH number 35.0 mg KOH/g), 600 g of 4,4′-methylenediphenyl diisocyanate (MDI; Desmodur® 44 MC L, Bayer) and 500 g of diisodecylphthalate (DIDP; Palatinol® Z, BASF) were reacted at 80° C. to give an NCO-terminated polyurethane polymer having a free isocyanate group content of 2.01% by weight.

The Thickener was Prepared as Follows:

A vacuum mixer was charged with 3000 g of diisodecylphthalate (DIDP; Palatinol® Z, BASF) and 480 g of 4,4′-methylenediphenyl diisocyanate (MDI; Desmodur® 44 MC L, Bayer) and this initial charge was gently warmed. Then 270 g of monobutylamine were added slowly dropwise with vigorous stirring. The resulting paste was stirred further for an hour with vacuum and cooling.

The ratio between the isocyanate groups and the aldimino groups in Examples 1 and 2 is 1.00/0.75.

The resultant one-component elastic adhesives were tested for application properties, skinover time and mechanical properties after curing.

Shear moduli were measured according to DIN 54 451 after 7 days' storage at room temperature and 50% relative humidity, at the temperature indicated in Table 1. The aluminium substrates used for this purpose were pretreated, prior to bonding, with Sika® Primer 204, available from Sika Schweiz A G.

The measure used for the open time was the skinover time (time until freedom from tack, tack-free time). To measure the skinover time, the adhesive was warmed to 40° C. and applied in a film thickness of about 2 mm to cardboard, and, at 23° C. and 50% relative humidity, a measurement was made of the time which elapsed before, when the surface of the composition was tapped gently by means of an LDPE pipette, there were for the first time no longer any residues remaining on the pipette.

TABLE 1
Composition of one-component elastic glazing adhesives of
Examples 1 and 2 and also of the comparative Example Ref.

| | Ref. | 1 | 2 |
|---|---|---|---|
| Polyurethane polymer PUP-1 | 44.0 | 44.0 | 44.0 |
| Dialdimine | — | A-2, | A-1, |
| | 0.0 | 8.0 | 7.8 |
| Liquid MDI | 1.3 | 1.3 | 1.3 |
| Plasticizer^{a} | 9.5 | 1.5 | 1.6 |
| Carbon black | 15.0 | 15.0 | 15.0 |
| Thickener | 10.0 | 10.0 | 10.0 |
| Kaolin | 20.0 | 20.0 | 20.0 |
| Acid catalyst^{b} | — | 0.2 | 0.2 |
| Tin catalyst^{c} | 0.2 | — | — |
| Skinover time [min] | 25 | 20-25 | 12-14 |
| Formation of bubbles | few | none | none |
| Shear modulus −20° C. | 5.9 MPa | 5.3 MPa | 4.4 MPa |
| Shear modulus 23° C. | 3.2 MPa | 3.6 MPa | 3.7 MPa |
| Shear modulus 80° C. | 2.5 MPa | 1.5 MPa | 3.4 MPa |
| Shear modulus −20° C. | 1.84 | 1.47 | 1.19 |
| Shear modulus 23° C. | | | |

^{a}Diisodecylphthalate (DIDP; Palatinol ® Z, BASF).
^{b}Salicylic acid (5% by weight in dioctyl adipate).
^{c}25% by weight dibutyltin dilaurate in diisodecyl phthalate.

Compositions 1 and 2 exhibited excellent adhesion to glass (pretreated by Sika® Primer-206 G+P) and painted metal panels (pretreated by Sika®Primer-209 C).

1. A moisture-reactive adhesive composition comprising:
at least one dialdimine having a formula (I) 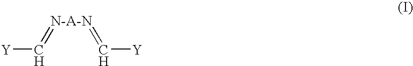
wherein:
A is a divalent aliphatic, cycloaliphatic or arylaliphatic hydrocarbon radical having 2 to 15 C atoms, and
Y is a radical of an aldehyde produced by removing an O═CH group therefrom; and
at least one polyurethane polymer P1 which is liquid at room temperature and comprises isocyanate groups, wherein:
after 7 days' storage at room temperature and 50% relative humidity, the adhesive composition has a ratio of a shear modulus measured at −20° C. to a shear modulus measured at 23° C. of less than 1.7, the shear moduli being measured at the stated temperatures according to DIN 54 451.

2. The moisture-reactive adhesive composition according to claim 1, wherein after 7 days' storage at room temperature and 50% relative humidity, the adhesive composition has a shear modulus at 80° C., measured according to DIN 54 451, of more than 1 MPa.

3. The moisture-reactive adhesive composition according to claim 1, wherein after 7 days' storage at room temperature and 50% relative humidity, the adhesive composition has a shear modulus at −20° C., measured according to DIN 54 451, of less than 6 MPa.

4. The moisture-reactive adhesive composition according to claim 1, wherein after 7 days' storage at room temperature and 50% relative humidity, the adhesive composition has a shear modulus at 23° C., measured according to DIN 54 451, of more than 3 MPa.

5. The moisture-reactive adhesive composition according to claim 1, wherein after 7 days' storage at room temperature and 50% relative humidity, the adhesive composition has a shear modulus at 80° C., measured according to DIN 54 451, of more than 2 MPa.

6. The moisture-reactive adhesive composition according to claim 1, wherein A is a radical produced by removing two amino groups from a diamine having a formula (III),
H₂N-A-NH₂ (III)
wherein the diamine is selected from the group consisting of:
ethylenediamine,
1,3-propanediaamine,
1,4-butanediamine,
1,5-pentanediamine,
1,6-hexanediamine,
1,8-octanediamine,
1,10-decanediamine,
1,12-dodecanediamine,
1,3-diaminocyclohexane,
1,4-diaminocyclohexane
bis(4-aminocyclohexyl)methane,
1,3-bis(aminomethyl)cyclohexane:
1,4-bis(aminomethyl)cyclohexane;
1,3-xylylenediamine, and
1,3 and 1,4-xylylenediamine.

7. The moisture-reactive adhesive composition according to claim 6, wherein the diamine is 1,6-hexanediamine.

8. The moisture-reactive adhesive composition according to claim 1, wherein the radical Y has a formula (II a) or (II b) 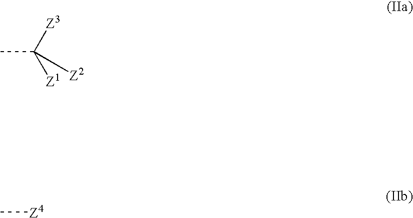
wherein:
Z¹ and Z² either
independently of one another are each a monovalent hydrocarbon radical having 1 to 12 C atoms, or
together form a portion of an unsubstituted or substituted carbocyclic ring having 5 to 8 C atoms, the portion formed by Z¹ and Z² together being a divalent hydrocarbon radical having 4 to 20 C atoms; and
Z³ is
a branched or unbranched alkyl, cycloalkyl, alkylene or cycloalkylene group,
a substituted or unsubstituted aryl or arylalkyl group, or
a radical having a formula O—R²; 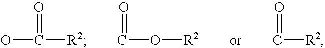
wherein R² is selected from a group consisting of:
a) a substituted or unsubstituted aryl, arylalkyl, cycloalkyl or alkyl group; and
b) a radical having a formula (VI) 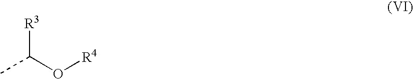
wherein:
R³ is
a hydrogen atom, or
an alkyl, cycloalkyl or arylalkyl group, and
R⁴ is either:
a hydrocarbon radical having 1 to 30 C atoms, the hydrocarbon radical optionally comprising ether oxygen atoms: or
a radical 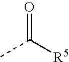
wherein R⁵ is hydrogen atom or for a hydrocarbon radical having 1 to 30 C atoms; and
Z⁴ is
a substituted or unsubstituted aryl or heteroaryl group having a ring size of 5 to 8atoms, or 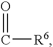
wherein: R⁶
is selected from the group consisting of:
a hydrogen atom,
an alkoxy group, and
a substituted or unsubstituted alkenyl or arylalkenyl group having at least 6 C atoms.

9. The moisture-reactive adhesive composition according to claim 1,
wherein the aldehyde from which the radical Y is derived has a formula (V a) 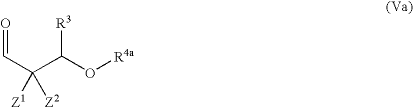
wherein:
Z¹ and Z² either
independently of one another each are a monovalent hydrocarbon radical having 1 to 12 C atoms, or
together together form a portion of an unsubstituted or substituted carbocyclic ring having 5 to 8 C atoms, the portion formed by Z¹ and Z² together being a divalent hydrocarbon radical having 4 to 20 C atoms;
R³is
a hydrogen atom, or
an alkyl, cycloalkyl or arylalkyl group, and
R^{4a} is a hydrocarbon radical having 1 to 30 C atoms, the hydrocarbon radical optionally comprising oxygen atoms.

10. A moisture-reactive adhesive composition according to claim 1, wherein the aldehyde from which the radical Y derives has the formula (V b) 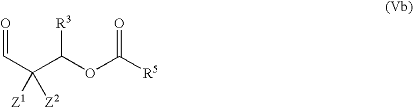
where
Z¹ and Z² either
independently of one another are a monovalent hydrocarbon radical having 1 to 12 C atoms, or
together form a portion of an unsubstituted or substituted carbocyclic ring having 5 to 8 C atoms, the portion formed by Z¹ and Z² together being a divalent hydrocarbon radical having 4 to 20 C atoms;
R³ is
a hydrogen atom or
an alkyl, cycloalkyl or arylalkyl group, and
R⁵ is
a hydrogen atom or
a hydrocarbon radical having 1 to 30 C atoms.

11. The moisture-reactive adhesive composition according to claim 1, wherein the adhesive composition comprises two or more polyurethane polymers P1.

12. The moisture-reactive adhesive composition according to claim 11, wherein the adhesive composition comprises a polyetherpolyol-based polyurethane polymer P1 and a polycarbonatepolyol-based polyurethane polymer P1.

13. The moisture-reactive adhesive composition according to claim 1, wherein the adhesive composition further comprises at least one polyurethane polymer P2 which is solid at room temperature and contains isocyanate groups.

14. The moisture-reactive adhesive composition according to claim 13, wherein the polyurethane polymer P2 which is solid at room temperature is prepared from polyesterpolyols and/or polycarbonatepolyols.

15. The moisture-reactive adhesive composition according to claim 1, wherein the fraction of the dialdimine of the formula (I) in the composition is chosen such that the ratio of the number of aldimino groups to the number of NCO groups in the composition is 0.5-<1, preferably at least 0.6-0.8, most preferably 0.65-0.75.

16. A method of bonding sheets in constructing means of transport, comprising adhering the sheet with the moisture-reactive adhesive composition of claim 1.

17. A method of reducing temperature dependency of a shear modulus of moisture-reactive polyurethane adhesives in accordance with DIN 54 452, comprising adding a dialdimine to a moisture-reactive adhesive composition the dialdimine having a formula (I) 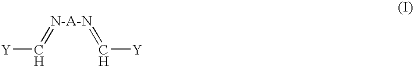
wherein:
A is a divalent aliphatic, cycloaliphatic or arylaliphatic hydrocarbon radical having 2 to 15 C atoms, and
Y is a radical of an aldehyde produced by removing an O═CH group therefrom.

18. A bonded article obtained by
adhesive bonding two substrates S1 and S2 by the moisture-reactive adhesive composition according to claim 1 and
moisture-curing the adhesive composition.

19. The bonded article according to claim 18, wherein the substrate S1 is a sheet, and the substrate S2 is a metal.
